(19) United States
(12) Patent Application Publication
(10) Pub. No.: US 2024/0267977 A1
(43) Pub. Date: Aug. 8, 2024

(54) UNIFIED TCI STATE FOR M-TRP MAC CE CONFIGURATION

(71) Applicant: MediaTek Singapore Pte. Ltd., Singapore (SG)

(72) Inventors: Gyu Bum KYUNG, San Jose, CA (US); Cheng-Rung TSAI, Hsinchu City (TW)

(21) Appl. No.: 18/564,750

(22) PCT Filed: Jul. 29, 2022
(86) PCT No.: PCT/CN2022/108977

§ 371 Date: Nov. 28, 2023

Related U.S. Application Data
(60) Provisional application No. 63/226,795, filed on Jul. 29, 2021.

(51) Int. Cl. H04W 76/20; H04W 72/12; H04W 72/232; H04W 80/02

(52) U.S. Cl. CPC H04W 76/20; H04W 72/12; H04W 72/232; H04W 80/02

(57) ABSTRACT

In an aspect of the disclosure, a method, a computer-readable medium, and an apparatus are provided. The apparatus may be a UE. The UE receives a first configuration for activating a first number of sets of TC states. Each set of the first number of sets includes at least a TCI state configured for communicating with a first TRP. The UE determines, based on an indication contained in the first configuration, that the first number of sets of TC states are activated for communicating with the first TRP or a second TRP in a first direction selected from an uplink direction and a downlink direction. The UE activates the first number of sets of TC states for communicating with the first TRP or the second TRP in the first direction.

### CROSS-REFERENCE TO RELATED APPLICATION(S)

This application claims the benefits of U.S. Provisional Application Ser. No. 63/226,795, entitled “METHOD AND APPARATUS FOR MULTI-TRP BEAM MANAGEMENT” and filed on Jul. 29, 2021, which is expressly incorporated by reference herein in its entirety.

### FIELD

The present disclosure relates generally to communication systems, and more particularly, to techniques of activating Transmission Configuration Indication (TCI) states at user equipment (UE).

### BACKGROUND

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. In one aspect, the UE receives a first configuration for activating a first number of sets of TCI states. Each set of the first number of sets includes at least a TCI state configured for communicating with a first TRP. The UE determines, based on an indication contained in the first configuration, that the first number of sets of TCI states are activated for communicating with the first TRP or a second TRP in a first direction selected from an uplink direction and a downlink direction. The UE activates the first number of sets of TCI states for communicating with the first TRP or the second TRP in the first direction.

In another aspect, the UE receives a first configuration for activating a first number of sets of TCI states, each set of the first number of sets including at least a TCI state configured for communicating in a downlink direction. The UE determines, based on an indication contained in the first configuration, that the first number of sets of TCI states are activated for communication with a first TRP selected from the first TRP and a second TRP. The UE activates the first number of sets of TCI states for communicating with the first TRP.

In yet another aspect, the UE receives a configuration for activating a first number of sets of TCI states. Each set of the first number of sets includes at least one of a TCI state configured for communicating with a first TRP in a downlink direction, a TCI state configured for communicating with a second TRP in a downlink direction, a TCI state configured for communicating with the first TRP in an uplink direction, and a TCI state configured for communicating with the second TRP in an uplink direction. The UE activating the first number of sets of TCI states.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating a first technique for activating TCI states at a UE.

FIG. 8 is a diagram illustrating a second technique for activating TCI states at a UE.

FIG. 9 is a diagram illustrating a third technique for activating TCI states at a UE.

FIG. 10 is a diagram illustrating a Medium Access Control (MAC) control element (CE) in a second configuration of the third technique.

FIG. 11 is a diagram illustrating an MAC CE in a third configuration of the third technique.

FIG. 12 is a flow chart of a first method (process) for activating TCI states.

FIG. 13 is a flow chart of a second method (process) for activating TCI states.

FIG. 14 is a flow chart of a third method (process) for activating TCI states.

FIG. 15 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

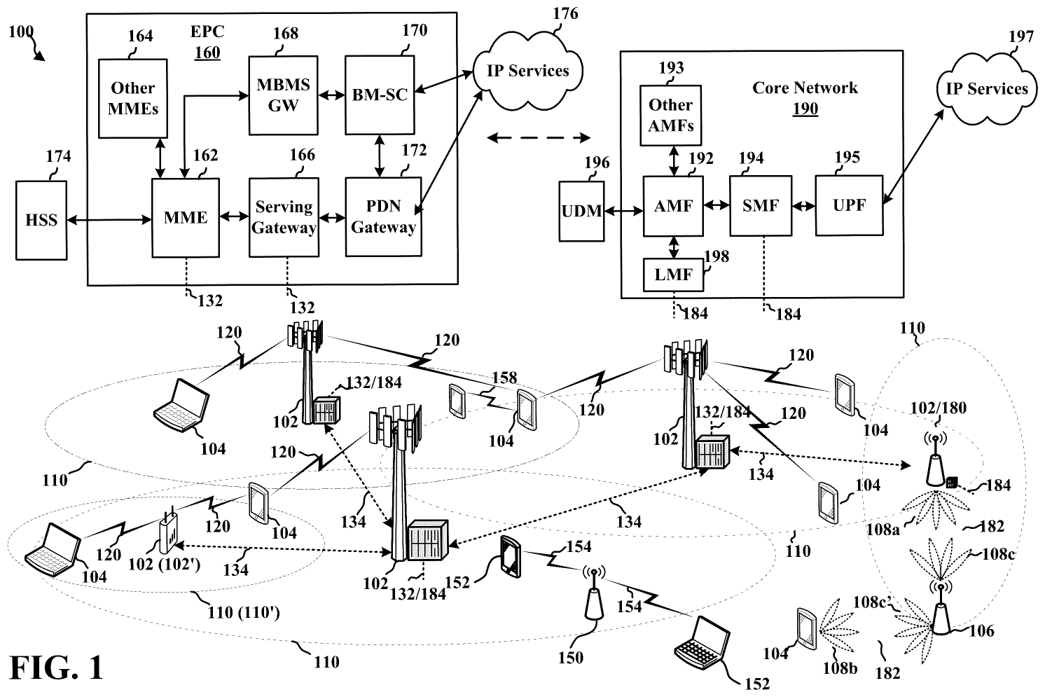

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

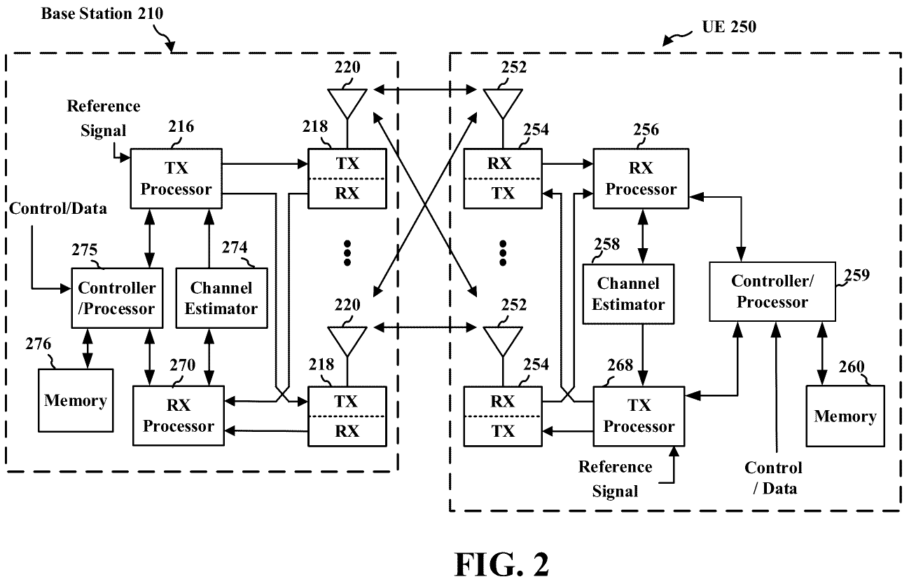

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

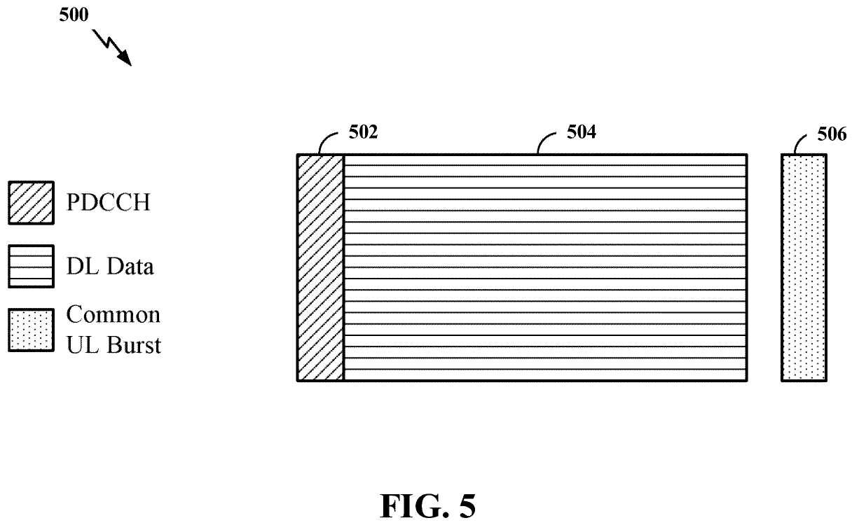

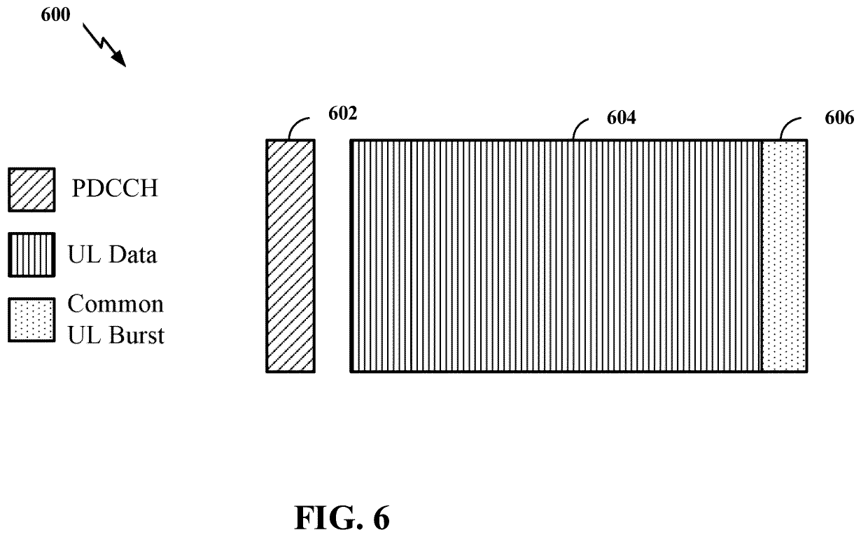

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

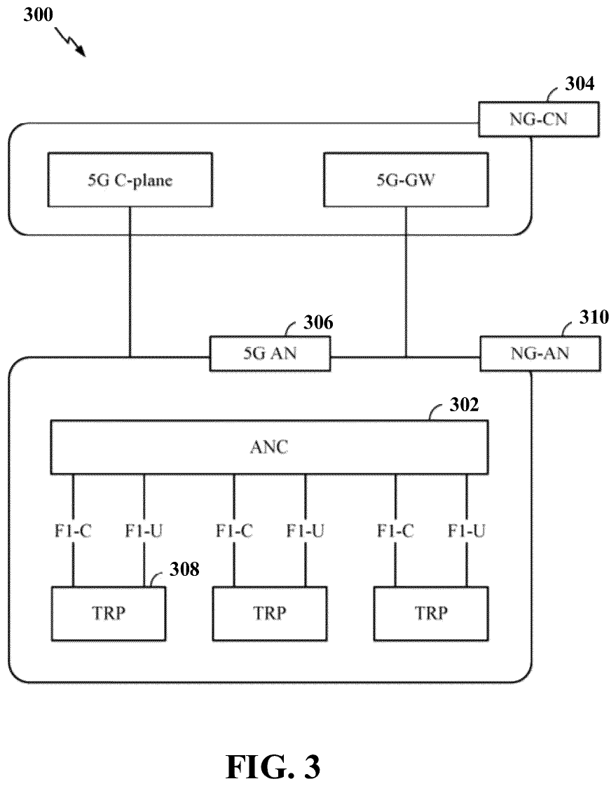

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

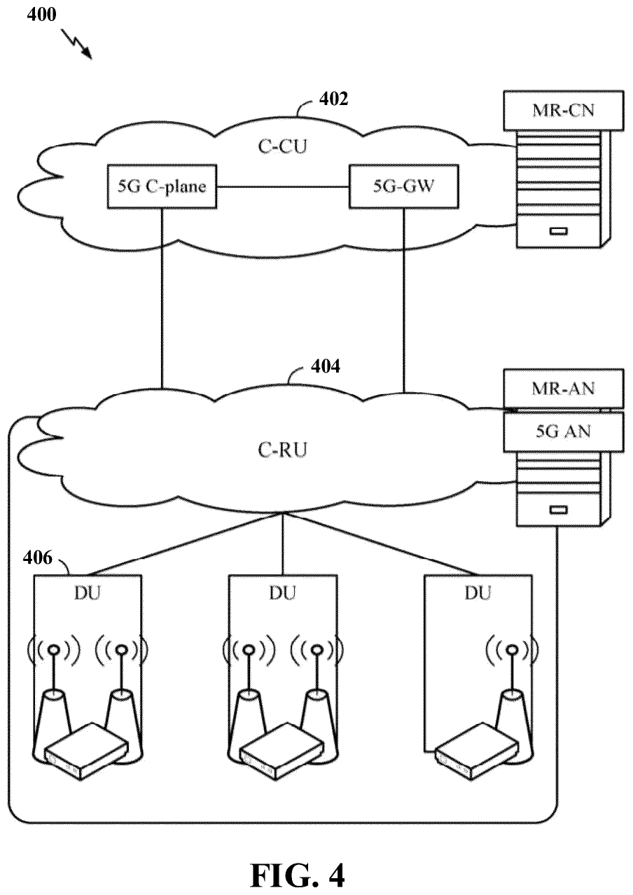

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

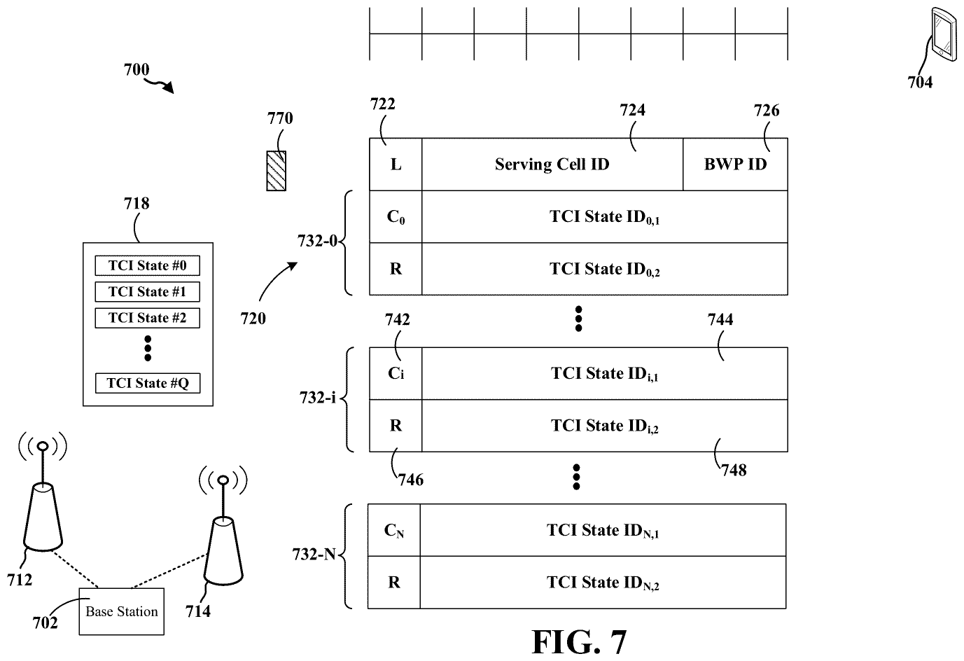

FIG. 7 is a diagram 700 illustrating for activating TCI states at a UE. In this example, a UE 704 concurrently communicate with a TRP 712 and a TRP 714, which may be controlled by a base station 702 and/or other base stations. The base station 702 informs the UE 704 about beams selected for data transmission, using a field known as the transmission configuration indication (TCI) state. The UE 704 can then look up the corresponding beam for reception. The base station 702 configures a TCI state pool 718 for a UE 704. The TCI state pool 718 contains configurations for (Q+1) TCI states #0 to #Q. Q is an integer and may be 127. Each TCI state can be identified by an index (e.g., #0, #1, . . . ).

The base station 702 may transmit a MAC CE 720, through the TRP 712 and/or the TRP 714, to the UE 704 for activating one or more TCI states of the TCI state pool 718. The MAC CE 720 contains a collection of bits that has a variable size. In this first technique, the MAC CE 720 has an L field 722, which may be 1 bit. The L field 722 indicates whether the MAC CE 720 is targeted for downlink direction (DL) or uplink direction (UL) TCI states. If this field is set to “0”, the MAC CE 720 is targeted for DL TCI states. If this field is set to “1”, the MAC CE 720 is targeted for UL TCI states.

Following the L field 722, the MAC CE 720 has a Serving Cell ID field 724, which may be 5 bits. The Serving Cell ID field 724 indicates the identity of the serving cell to which the MAC CE 720 applies. Following the Serving Cell ID field 724, the MAC CE 720 has a BWP field 726, which may be 2 bits. The BWP field 726 indicates a BWP to which the MAC CE 720 applies.

Following the BWP field 726, the MAC CE 720 has (N+1) sets of data 732-0, 732-i, . . . , 732-N that correspond to (N+1) codepoints. N is an integer and may be 7. Each set of data 732-i (i E {0, 1, . . . , N}) has a Cᵢ field 742, a TCI-State-ID field_{(i,1)} 744, an optional R field 746, and an optional TCI-State-ID field_{(i,2)} 748 in that order.

The Cᵢ field 742 indicates whether the optional R field 746 and TCI-State-ID field_{(i,2)} 748 are present in the set of data 732-i. In particular, the Cᵢ field 742 may be 1 bit. If the Cᵢ field 742 is set to “1”, the optional R field 746 and TCI-State-ID field_{(i,2)} 748 are present in the set of data 732-i. If the Cᵢ field 742 is set to “0”, the optional R field 746 and TCI-State-ID field_{(i,2)} 748 are not present in the set of data 732-i.

As described supra, the TCI-State-ID field_{(i,1)} 744 follows the Cᵢ field 742 and may be 7 bits. The value of the TCI-State-ID field_{(i,1)} 744 corresponds to an index of a particular TCI state in the TCI state pool 718. Further, the particular TCI state is used for communicating with the TRP 712 (i.e., a default TRP). The UE 704, accordingly, activates the particular TCI state. For example, the UE 704 may prepare to be ready to operate according to the particular TCI state (e.g., preparing a corresponding spatial filer).

When the R field 746 and the TCI-State-ID field_{(i,2)} 748 are present, the R field 746 is a reserved field. The R field 746 may be 1 bit and set to “0”. The TCI-State-ID field_{(i,2)} 748, similar to the TCI-State-ID field_{(i,1)} 744, may be 7 bits. The value of the TCI-State-ID field_{(i,2)} 748 corresponds to an index of a particular TCI state in the TCI state pool 718. Further, the particular TCI state is used for communicating with the TRP 714 (i.e., another TRP).

As described supra, the set of data 732-i corresponds to the codepoint i. The respective codepoint to which each set of the (N+1) sets of data 732-0, 732-i, . . . , 732-N is mapped is determined by the ordinal position of the set. For example, the set of data 732-0 is mapped to the codepoint 0, the set of data 732-1 is mapped to the codepoint 1, and so on.

The UE 704 may receive a first MAC CE 720 containing a first collection of data for activating downlink TCI states and a second MAC CE 720 containing a second collection of data for activating uplink TCI states. Each collection of data contains a corresponding L field 722 indicating the corresponding communication direction.

Subsequently, the UE 704 receives DCI 770 from the base station 702 via the TRP 712 or the TRP 714. The DCI 770 contains indicators that indicates a codepoint. The indicator may be 3 bits.

The DCI 770 also indicates a communication direction (UL or DL). The UE 704 selects a collection of data corresponding to the indicated communication direction. Based on the codepoint, the UE 704 locates a corresponding set of data from the (N+1) sets of data 732-0, 732-i, . . . , 732-N in the corresponding collection of data. Assuming the codepoint is i, the UE 704 then use the TCI state indicated by the TCI-State-ID field_{(i,1)} 744 to communicate with the TRP 712 in the indicated communication direction. When the TCI-State-ID field_{(i,2)} 748 presents, the UE 704 use the TCI state indicated by the TCI-State-ID field_{(i,2)} 748 to communicate with the TRP 714 in the indicated communication direction.

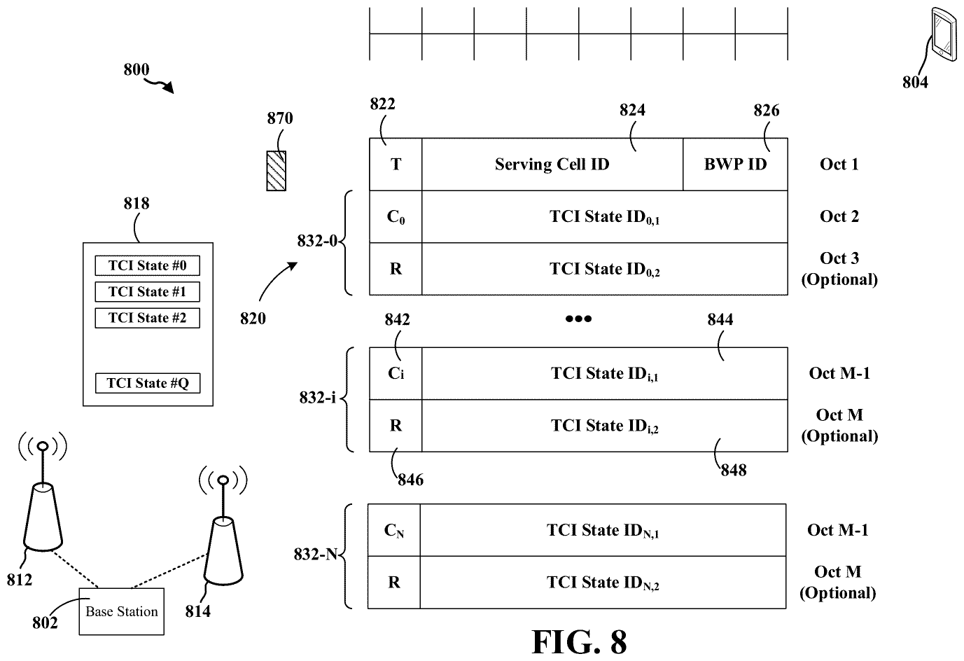

FIG. 8 is a diagram 800 illustrating a second technique for activating TCI states at a UE. In this example, a UE 804 concurrently communicate with a TRP 812 and a TRP 814, which may be controlled by a base station 802 and/or other base stations. The base station 802 configures a TCI state pool 818 for the UE 804. The TCI state pool 818 contains configurations for (Q+1) TCI states #0 to #Q. Q is an integer and may be 127. Each TCI state can be identified by an index (e.g., #0, #1, . . . ).

The base station 802 may transmit a MAC CE 820, through the TRP 812 and/or the TRP 814, to the UE 804 for activating one or more TCI states of the TCI state pool 818. The MAC CE 820 contains a collection of data that has a variable size. In this second technique, the MAC CE 820 has a T field 822, which may be 1 bit. The T field 822 indicates whether the MAC CE 820 is targeted at the TRP 812 or the TRP 814. That is, the TCI states activated by the MAC CE 820 is for communication with the TRP 812 to the TRP 814. For example, if this field is set to “0”, the MAC CE 820 is targeted at the TRP 712. If this field is set to “1”, the MAC CE 820 is targeted at the TRP 714.

Following the T field 822, the MAC CE 820 has a Serving Cell ID field 824, which may be 5 bits. The Serving Cell ID field 824 indicates the identity of the serving cell to which the MAC CE 820 applies. Following the Serving Cell ID field 824, the MAC CE 820 has a BWP field 826, which may be 2 bits. The BWP field 826 indicates a BWP to which the MAC CE 820 applies.

Following the BWP field 826, the MAC CE 820 has (N+1) sets of data 832-0, 832-i, . . . , 832-N that correspond to (N+1) codepoints. N is an integer and may be 7. Each set of data 832-i (i E {0, 1, . . . , N}) has a Cᵢ field 842, a TCI-State-ID field_{(i,1)} 844, an optional R field 846, and an optional TCI-State-ID field_{(i,2)} 848 in that order.

The Cᵢ field 842 indicates whether the optional R field 846 and TCI-State-ID field_{(i,2)} 848 are present in the set of data 832-i. In particular, the Cᵢ field 842 may be 1 bit. If the Cᵢ field 842 is set to “1”, the optional R field 846 and TCI-State-ID field_{(i,2)} 848 are present in the set of data 832-i. If the Cᵢ field 842 is set to “0”, the optional R field 846 and TCI-State-ID field_{(i,2)} 848 are not present in the set of data 832-i.

As described supra, the TCI-State-ID field_{(i,1)} 844 follows the Cᵢ field 842 and may be 7 bits. The value of the TCI-State-ID field_{(i,1)} 844 corresponds to an index of a particular TCI state in the TCI state pool 818. Further, the particular TCI state is used for communicating in a downlink direction with the TRP indicated by the T field 822 (e.g., the TRP 812). The UE 804, accordingly, activates the particular TCI state. For example, the UE 804 may prepare to be ready to operate according to the particular TCI state (e.g., preparing a corresponding spatial filer).

When the R field 846 and the TCI-State-ID field_{(i,2)} 848 are present, the R field 846 is a reserved field. The R field 846 may be 1 bit and set to “0”. The TCI-State-ID field_{(i,2)} 848, similar to the TCI-State-ID field_{(i,1)} 844, may be 7 bits. The value of the TCI-State-ID field_{(i,2)} 848 corresponds to an index of a particular TCI state in the TCI state pool 818. Further, the particular TCI state is used for communicating in an uplink direction with the TRP indicated by the T field 822.

When the R field 846 and the TCI-State-ID field_{(i,2)} 848 are not present, the UE 804 may determine that the particular TCI state indicated by the TCI-State-ID field_{(i,1)} 844 is also used for communicating in an uplink direction with the TRP indicated by the T field 822.

As described supra, the set of data 832-i corresponds to the codepoint i. The respective codepoint to which each set of the (N+1) sets of data 832-0, 832-i, . . . , 832-N is mapped is determined by the ordinal position of the set. For example, the set of data 832-0 is mapped to the codepoint 0, the set of data 832-1 is mapped to the codepoint 1, and so on.

The UE 804 may receive a first MAC CE 820 containing a first collection of data for activating TCI states for communication with the TRP 812 and a second MAC CE 820 containing a second collection of data for activating TCI states for communication with the TRP 814. Each collection of data contains a corresponding T field 822 indicating the corresponding TRP.

Subsequently, the UE 804 receives DCI 870 from the base station 802 via the TRP 812 or the TRP 814. The DCI 870 contains indicators that indicates a codepoint. The indicator may be 3 bits. The DCI 870 also indicates a target TRP (e.g., the TRP 812 or the TRP 814). The UE 804 selects a collection of data corresponding to the indicated TRP. Based on the codepoint, the UE 804 locates a corresponding set of data from the (N+1) sets of data 832-0, 832-i, . . . , 832-N in the corresponding collection of data. Assuming the codepoint is i, the UE 804 then use the TCI state indicated by the TCI-State-ID field_{(i,1)} 844 to communicate with the target TRP in the downlink direction. When the TCI-State-ID field_{(i,2)} 848 is present, the UE 804 use the TCI state indicated by the TCI-State-ID field_{(i,2)} 848 to communicate with the target TRP in the uplink direction. When the TCI-State-ID field_{(i,2)} 848 is not present, the UE 804 may also use the TCI state indicated by the TCI-State-ID field_{(i,1)} 844 to communicate with the target TRP in the uplink direction.

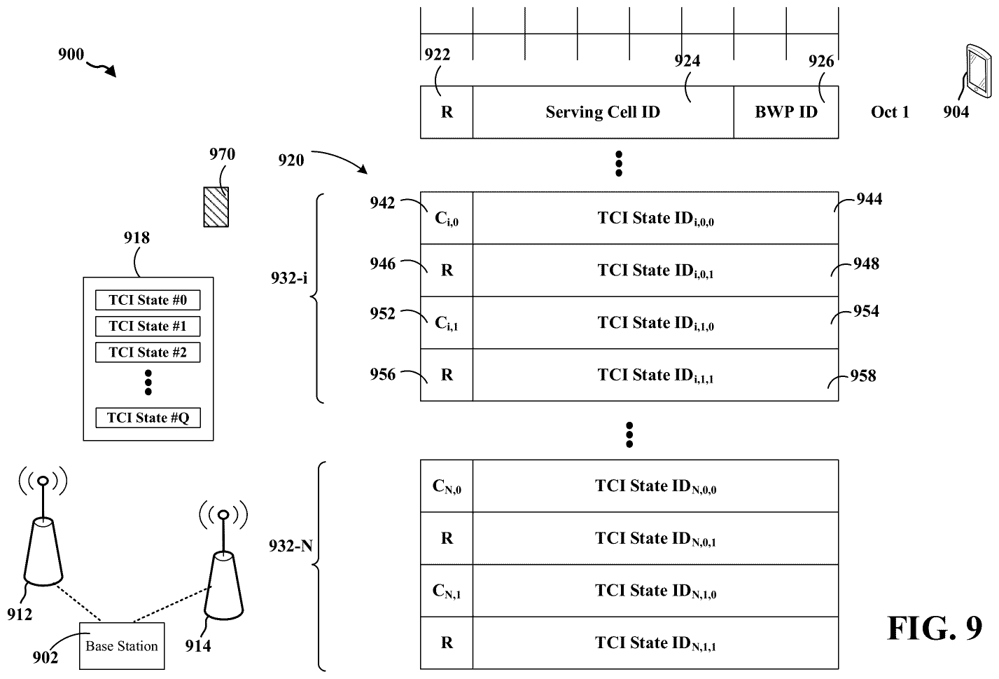

FIG. 9 is a diagram 900 illustrating a third technique for activating TCI states at a UE. In this example, a UE 904 concurrently communicate with a TRP 912 and a TRP 914, which may be controlled by a base station 902 and/or other base stations. The base station 902 configures a TCI state pool 918 for the UE 904. The TCI state pool 918 contains configurations for (Q+1) TCI states #0 to #Q. Q is an integer and may be 127. Each TCI state can be identified by an index (e.g., #0, #1, . . . ).

The base station 902 may transmit an MAC CE 920, through the TRP 912 and/or the TRP 914, to the UE 904 for activating one or more TCI states of the TCI state pool 918. The MAC CE 920 contains a collection of data that has a variable size.

In a first configuration of the third technique, the MAC CE 920 has a R field 922, which may be 1 bit and set to “0”. Following the R field 922, the MAC CE 920 has a Serving Cell ID field 924, which may be 5 bits. The Serving Cell ID field 924 indicates the identity of the serving cell to which the MAC CE 920 applies. Following the Serving Cell ID field 924, the MAC CE 920 has a BWP field 926, which may be 2 bits. The BWP field 926 indicates a BWP to which the MAC CE 920 applies.

Following the BWP field 926, the MAC CE 920 has (N+1) sets of data 932-0, 932-i, . . . , 932-N that correspond to (N+1) codepoints. N is an integer and may be 7. Each set of data 932-i (i E {0, 1, . . . , N}) has a C_{i,0} field 942, a TCI-State-ID field_{(i,0,0)} 944, an optional R field 946, and an optional TCI-State-ID field_{(i,0,1)} 948, a C_{i,1} field 952, a TCI-State-ID field_{(i,1,0)} 954, an optional R field 956, and an optional TCI-State-ID field_{(i,1,1)} 958, in that order.

The C_{i,0} field 942 indicates whether the optional R field 946 and TCI-State-ID field_{(i,0,1)} 948 are present in the set of data 932-i. In particular, the C_{i,0} field 942 may be 1 bit. If the C_{i,0} field 942 is set to “1”, the optional R field 946 and TCI-State-ID field_{(i,0,1)} 948 are present in the set of data 932-i. If the C_{i,0} field 942 is set to “0”, the optional R field 946 and TCI-State-ID field_{(i,0,1)} 948 are not present in the set of data 932-i.

As described supra, the TCI-State-ID field_{(i,0,0)} 944 follows the C_{i,0} field 942 and may be 7 bits. The value of the TCI-State-ID field_{(i,0,0)} 944 corresponds to an index of a particular TCI state in the TCI state pool 918. Further, the particular TCI state is used for communicating in the downlink direction with the TRP 912 (i.e., a default TRP)). The UE 904, accordingly, activates the particular TCI state.

When the R field 946 and the TCI-State-ID field_{(i,0,1)} 948 are present, the R field 946 is a reserved field. The R field 946 may be 1 bit and set to “0”. The TCI-State-ID field_{(i,0,1)} 948, similar to the TCI-State-ID field_{(i,0,0)} 944, may be 7 bits. The value of the TCI-State-ID field_{(i,0,1)} 948 corresponds to an index of a particular TCI state in the TCI state pool 918. Further, the particular TCI state is used for communicating in the downlink direction with the TRP 914 (i.e., another TRP).

The C_{i,j} field 952 indicates whether the optional R field 956 and TCI-State-ID field_{(i,1,1)} 958 are present in the set of data 932-i. In particular, the C_{i,1} field 952 may be 1 bit. If the C_{i,1} field 952 is set to “1”, the optional R field 956 and TCI-State-ID field_{(i,1,1)} 958 are present in the set of data 932-i. If the C_{i,0} field 942 is set to “0”, the optional R field 956 and TCI-State-ID field_{(i,1,1)} 958 are not present in the set of data 932-i.

The TCI-State-ID field_{(i,1,0)} 954, following the C_{i,1} field 952, may be 7 bits. The value of the TCI-State-ID field_{(i,1,0)} 954 corresponds to an index of a particular TCI state in the TCI state pool 918. Further, the particular TCI state is used for communicating in the uplink direction with the TRP 912.

When the R field 956 and the TCI-State-ID field_{(i,1,1)} 958 are present, the R field 956 is a reserved field. The R field 956 may be 1 bit and set to “0”. The TCI-State-ID field_{(i,1,1)} 958 may be 7 bits. The value of the TCI-State-ID field_{(i,1,1)} 958 corresponds to an index of a particular TCI state in the TCI state pool 918. Further, the particular TCI state is used for communicating in the uplink direction with the TRP 914.

As described supra, the set of data 932-i corresponds to the codepoint i. The respective codepoint to which each set of the (N+1) sets of data 932-0, 932-i, . . . , 932-N is mapped is determined by the ordinal position of the set. For example, the set of data 932-0 is mapped to the codepoint 0, the set of data 932-1 is mapped to the codepoint 1, and so on.

Subsequently, the UE 904 receives DCI 970 from the base station 902 via the TRP 912 or the TRP 914. The DCI 970 contains indicators that indicates a codepoint. The indicator may be 3 bits. The DCI 970 also indicates a target TRP (e.g., the TRP 912 or the TRP 914) and a target communication direction (e.g., downlink or uplink). Based on the codepoint, the UE 904 locates a corresponding set of data from the (N+1) sets of data 932-0, 932-i, . . . , 932-N in the corresponding collection of data. Assuming the codepoint is i, the UE 904 then selects, in the set of data 932-i, the TCI-State-ID field corresponding to the target TRP and the target communication direction. Based on the value of the selected TCI-State-ID field, the UE 704 choose a TCI state for communicating with the target TRP in the target direction.

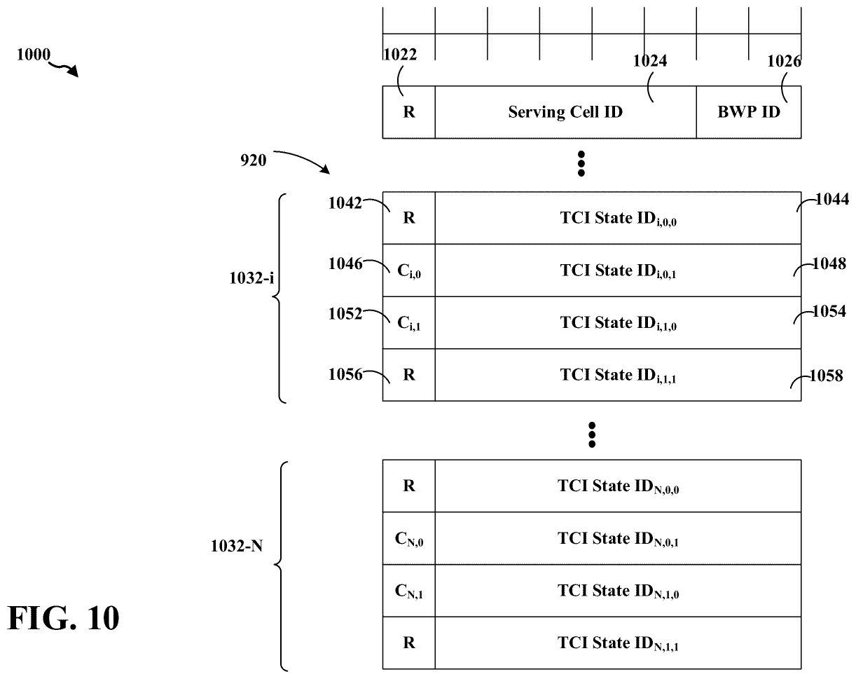

FIG. 10 is a diagram 1000 illustrating the MAC CE 920 in a second configuration of the third technique. The MAC CE 920 has an R field 1022, which may be 1 bit and set to “0”. Following the R field 1022, the MAC CE 920 has a Serving Cell ID field 1024, which may be 5 bits. The Serving Cell ID field 1024 indicates the identity of the serving cell to which the MAC CE 920 applies. Following the Serving Cell ID field 1024, the MAC CE 920 has a BWP field 1026, which may be 2 bits. The BWP field 1026 indicates a BWP to which the MAC CE 920 applies.

Following the BWP field 1026, the MAC CE 920 has (N+1) sets of data 1032-0, 1032-i, . . . 1032-N that correspond to (N+1) codepoints. N is an integer and may be 7. In this second configuration of the third technique, each set of data 1032-i (i∈{0, 1, . . . , N}) has an R field 1042, a TCI-State-ID field_{(i,0,0)} 1044, a C_{i,0} field 1046, a TCI-State-ID field_{(i,0,1)} 1048, an optional C_{i,1} field 1052, an optional TCI-State-ID field_{(i,1,0)} 1054, an optional R field 1056, and an optional TCI-State-ID field_{(i,1,1)} 1058, in that order.

The R field 1042 is a reserved field. The R field 1042 may be 1 bit and set to “0”. The TCI-State-ID field_{(i,0,0)} 1044 may be 7 bits. The value of the TCI-State-ID field_{(i,0,0)} 1044 corresponds to an index of a particular TCI state in the TCI state pool 918. Further, the particular TCI state is used for communicating in the downlink direction with the TRP 912 (i.e., a default TRP)). The UE 904, accordingly, activates the particular TCI state.

The C_{i,0} field 1046 indicates whether the optional C_{i,1} field 1052 and TCI-State-ID field_{(i,1,0)} 1054 are present in the set of data 1032-i. In particular, the C_{i,0} field 1046 may be 1 bit. If the C_{i,0} field 1046 is set to “1”, the optional C_{i,1} field 1052 and TCI-State-ID field_{(i,1,0)} 1054 are present in the set of data 1032-i. If the C_{i,0} field 1046 is set to “0”, the optional C_{i,1} field 1052 and TCI-State-ID field_{(i,1,0)} 1054 are not present in the set of data 1032-i.

The TCI-State-ID field_{(i,0,1)} 1048 follows the C_{i,0} field 1046 and may be 7 bits. The value of the TCI-State-ID field_{(i,0,1)} 1048 corresponds to an index of a particular TCI state in the TCI state pool 918. Further, the particular TCI state is used for communicating in the uplink direction with the TRP 912 (i.e., the default TRP).

When the C_{i,1} field 1052 and the TCI-State-ID field_{(i,1,0)} 1054 are present, the C_{i,1} field 1052 indicates whether the optional R field 1056 and TCI-State-ID field_{(i,1,1)} 1058 are present in the set of data 1032-i. In particular, the C_{i,1} field 1052 may be 1 bit. If the C_{i,1} field 1052 is set to “1”, the optional R field 1056 and TCI-State-ID field_{(i,1,1)} 1058 are present in the set of data 1032-i. If the C_{i,0} field 1046 is set to “0”, the optional R field 1056 and TCI-State-ID field_{(i,1,1)} 1058 are not present in the set of data 1032-i.

The TCI-State-ID field_{(i,1,0)} 1054, following the C_{i,1} field 1052, may be 7 bits. The value of the TCI-State-ID field_{(i,1,0)} 1054 corresponds to an index of a particular TCI state in the TCI state pool 918. Further, the particular TCI state is used for communicating in the downlink direction with the TRP 914 (i.e., another TRP).

When the R field 1056 and the TCI-State-ID field_{(i,1,1)} 1058 are present, the R field 1056 is a reserved field. The R field 1056 may be 1 bit and set to “0”. The TCI-State-ID field_{(i,1,1)} 1058 may be 7 bits. The value of the TCI-State-ID field_{(i,1,1)} 1058 corresponds to an index of a particular TCI state in the TCI state pool 918. Further, the particular TCI state is used for communicating in the uplink direction with the TRP 914.

As described supra, the set of data 1032-i corresponds to the codepoint i. The respective codepoint to which each set of the (N+1) sets of data 1032-0, 1032-i, . . . , 1032-N is mapped is determined by the ordinal position of the set. For example, the set of data 1032-0 is mapped to the codepoint 0, the set of data 1032-1 is mapped to the codepoint 1, and so on.

Subsequently, as described supra, the UE 904 receives the DCI 970 from the base station 902 via the TRP 912 or the TRP 914. The DCI 970 contains indicators that indicates a codepoint. The DCI 970 also indicates a target TRP (e.g., the TRP 912 or the TRP 914) and a target communication direction (e.g., downlink or uplink). Based on the codepoint, the UE 904 locates a corresponding set of data from the (N+1) sets of data 1032-0, 1032-i, . . . , 1032-N and determines a corresponding TCI state for communicating with the target TRP in the target direction.

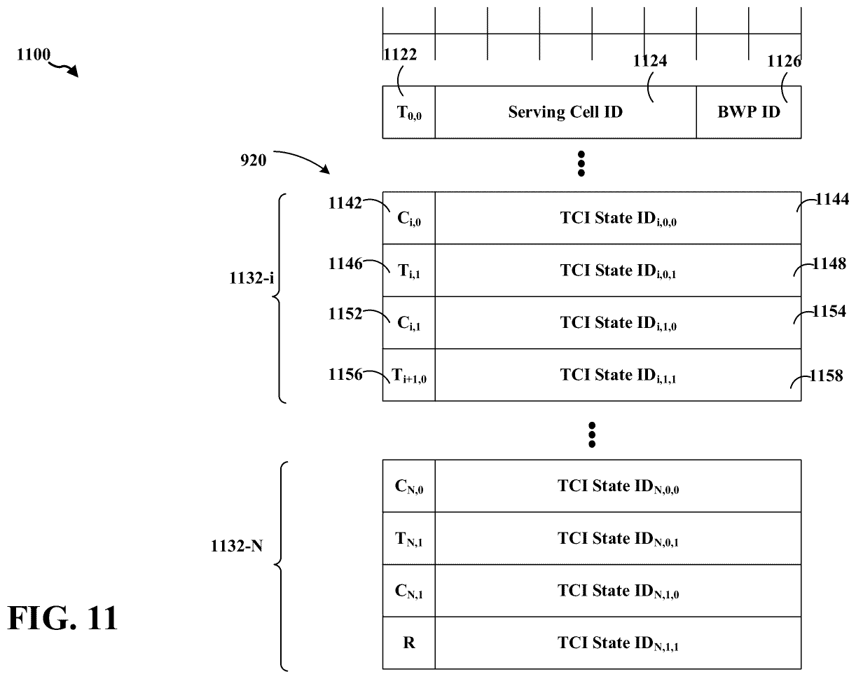

FIG. 11 is a diagram 1000 illustrating the MAC CE 920 in a third configuration of the third technique. The MAC CE 920 has an T_{0,0} field 1122, which is described infra. Following the T_{0,0} field 1122, the MAC CE 920 has a Serving Cell ID field 1124, which may be 5 bits. The Serving Cell ID field 1124 indicates the identity of the serving cell to which the MAC CE 920 applies. Following the Serving Cell ID field 1124, the MAC CE 920 has a BWP field 1126, which may be 2 bits. The BWP field 1126 indicates a BWP to which the MAC CE 920 applies.

Following the BWP field 1126, the MAC CE 920 has (N+1) sets of data 1132-0, 1132-i, . . . 1132-N that correspond to (N+1) codepoints. N is an integer and may be 7. In this third configuration of the third technique, each set of data 1132-i (i∈{0, 1, . . . , N}) has a C_{i,0} field 1142, a TCI-State-ID field_{(i,0,0)} 1144, a T_{i,1} field 1146, a TCI-State-ID field_{(i,0,1)} 1148, a C_{i,1} field 1152, a TCI-State-ID field_{(i,1,0)} 1154, a T_{i+1,0} field 1156, and a TCI-State-ID field_{(i,1,1)} 1158, in that order. As described infra, each field may be optional.

The T_{0,0} field 1122 (described supra) indicates, when i is 0, whether the C_{i,0} field 1142 and TCI-State-ID field_{(i,0,0)} 1144 are present in the set of data 1132-i. In particular, the T_{0,0} field 1122 may be 1 bit. If the C_{i,0} field 1142 is set to “1”, the C_{i,0} field 1142 and TCI-State-ID field_{(i,0,0)} 1144 are present in the set of data 1132-i. If the T_{0,0} field 1122 is set to “0”, the C_{i,0} field 1142 and TCI-State-ID field_{(i,0,0)} 1144 are not present in the set of data 1132-i.

For i∈{0, 1, . . . , N}, when the C_{i,0} field 1142 is present, the C_{i,0} field 1142 indicates whether the T_{i,1} field 1146 and TCI-State-ID field_{(i,0,1)} 1148 are present in the set of data 1132-i. In particular, the C_{i,0} field 1142 may be 1 bit. If the C_{i,0} field 1142 is set to “1”, the T_{i,1} field 1146 and TCI-State-ID field_{(i,0,1)} 1148 are present in the set of data 1132-i. If the C_{i,0} field 1142 is set to “0”, the T_{i,1} field 1146 and TCI-State-ID field_{(i,0,1)} 1148 are not present in the set of data 1132-i.

The TCI-State-ID field_{(i,0,0)} 1144 may be 7 bits. The value of the TCI-State-ID field_{(i,0,0)} 1144 corresponds to an index of a particular TCI state in the TCI state pool 918. Further, the particular TCI state is used for communicating in the downlink direction with the TRP 912 (i.e., a default TRP). The UE 904, accordingly, activates the particular TCI state.

The T_{i,1} field 1146 indicates whether the C_{i,1} field 1152 and TCI-State-ID field_{(i,1,0)} 1154 are present in the set of data 1132-i. If the T_{i,1} field 1146 is set to “1”, the C_{i,1} field 1152 and TCI-State-ID field_{(i,1,0)} 1154 are present in the set of data 1132-i. If the T, field 1146 is set to “0”, the C₁, field 1152 and TCI-State-ID field_{(i,1,0)} 1154 are not present in the set of data 1132-i.

The TCI-State-ID field_{(i,0,1)} 1148 follows the T_{i,1} field 1146 and may be 7 bits. The value of the TCI-State-ID field_{(i,0,1)} 1148 corresponds to an index of a particular TCI state in the TCI state pool 918. Further, the particular TCI state is used for communicating in the downlink direction with the TRP 914 (i.e., another TRP).

When the C_{i,1} field 1152 and the TCI-State-ID field_{(i,1,0)} 1154 are present, the Ct, field 1152 indicates whether the T_{i+1,0} field 1156 and TCI-State-ID field_{(i,1,1)} 1158 are present in the set of data 1132-i. In particular, the C_{i,1} field 1152 may be 1 bit. If the C_{i,1} field 1152 is set to “1”, the T_{i+1,0} field 1156 and TCI-State-ID field_{(i,1,1)} 1158 are present in the set of data 1132-i. If the C_{i,0} field 1142 is set to “0”, the T_{i+1,0} field 1156 and TCI-State-ID field_{(i,1,1)} 1158 are not present in the set of data 1132-i.

The TCI-State-ID field_{(i,1,0)} 1154, following the Ct, field 1152, may be 7 bits. The value of the TCI-State-ID field_{(i,1,0)} 1154 corresponds to an index of a particular TCI state in the TCI state pool 918. Further, the particular TCI state is used for communicating in the uplink direction with the TRP 912.

When the T_{i+1,0} field 1156 and the TCI-State-ID field_{(i,1,1)} 1158 are present, the T_{i+1,0} field 1156 indicates whether the C_{(i+i),0} field 1142 and TCI-State-ID field_{(i+1,0,0)} 1144 are present in the set of data 1132-(i+1). The TCI-State-ID field_{(i,1,1)} 1158 may be 7 bits. The value of the TCI-State-ID field_{(i,1,1)} 1158 corresponds to an index of a particular TCI state in the TCI state pool 918. Further, the particular TCI state is used for communicating in the uplink direction with the TRP 914.

As described supra, the set of data 1132-i corresponds to the codepoint i. The respective codepoint to which each set of the (N+1) sets of data 1132-0, 1132-i, . . . , 1132-N is mapped is determined by the ordinal position of the set. For example, the set of data 1132-0 is mapped to the codepoint 0, the set of data 1132-1 is mapped to the codepoint 1, and so on.

Subsequently, as described supra, the UE 904 receives DCI 970 from the base station 902 via the TRP 912 or the TRP 914. The DCI 970 contains indicators that indicates a codepoint. The DCI 970 also indicates a target TRP (e.g., the TRP 912 or the TRP 914) and a target communication direction (e.g., downlink or uplink). Based on the codepoint, the UE 904 locates a corresponding set of data from the (N+1) sets of data 1132-0, 1132-i, . . . , 1132-N and determines a corresponding TCI state for communicating with the target TRP in the target direction.

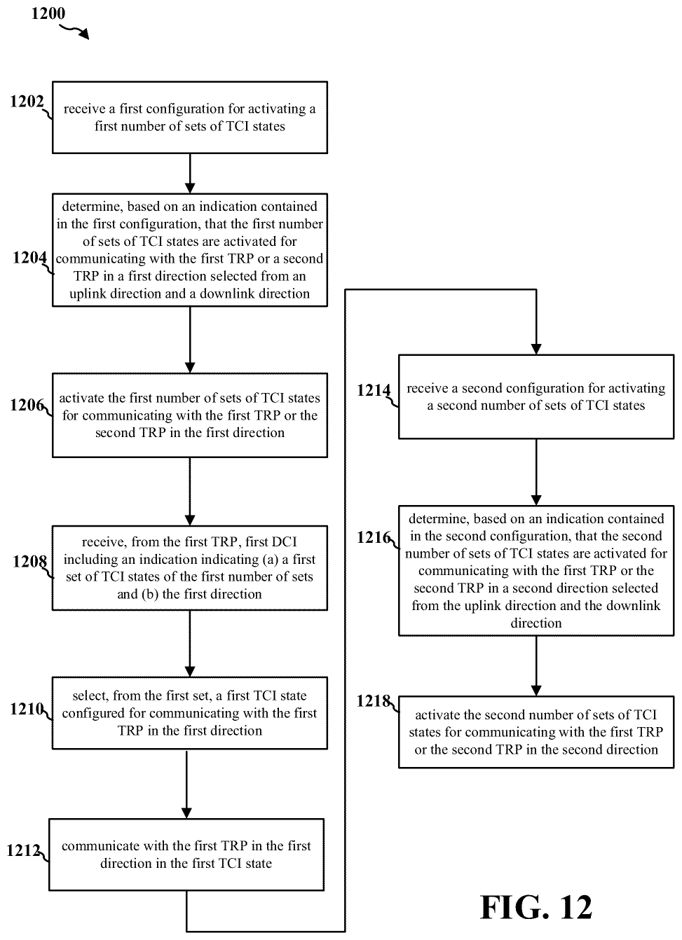

FIG. 12 is a flow chart 1200 of a first method (process) for activating TCI states. The method may be performed by a UE (e.g., the UE 704). At operation 1202, the UE receives a first configuration for activating a first number of sets of TCI states. Each set of the first number of sets includes at least a TCI state configured for communicating with a first TRP. At operation 1204, the UE determines, based on an indication contained in the first configuration, that the first number of sets of TCI states are activated for communicating with the first TRP or a second TRP in a first direction selected from an uplink direction and a downlink direction. And at operation 1206, the UE activates the first number of sets of TCI states for communicating with the first TRP or the second TRP in the first direction.

At operation 1208, the UE receives, from the first TRP, first DCI including an indication indicating (a) a first set of TCI states of the first number of sets and (b) the first direction. At operation 1210, the UE selects, from the first set, a first TCI state configured for communicating with the first TRP in the first direction. At operation 1212, the UE communicates with the first TRP in the first direction in the first TCI state.

In certain configurations, the UE receives, from a second TRP, second DCI including an indication indicating (a) the first set and (b) the first direction. The UE selects, from the first set, a second TCI state configured for communicating with the second TRP in the first direction. The UE communicates with the second TRP in the first direction in the second TCI state.

At operation 1214, the UE receives a second configuration for activating a second number of sets of TCI states. Each set of the second number of sets includes at least a TCI state configured for communicating with the first TRP. At operation 1216, the UE determines, based on an indication contained in the second configuration, that the second number of sets of TCI states are activated for communicating with the first TRP or the second TRP in a second direction selected from the uplink direction and the downlink direction. At operation 1218, the UE activates the second number of sets of TCI states for communicating with the first TRP or the second TRP in the second direction.

In certain configurations, the UE receives, from the first TRP, third DCI including an indication indicating (a) a third set of TCI states of the second number of sets and (b) the second direction. The UE selects, from the third set, a third TCI state configured for communicating with the first TRP in the second direction.

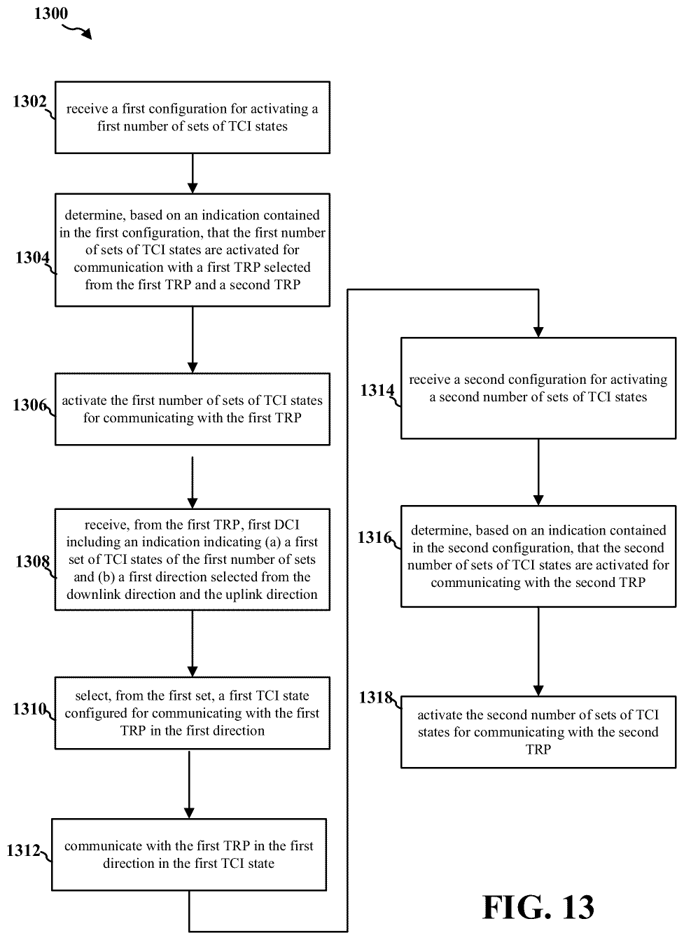

FIG. 13 is a flow chart 1300 of a second method (process) for activating TCI states. The method may be performed by a UE (e.g., the UE 704). At operation 1302, the UE receives a first configuration for activating a first number of sets of transmission configuration indication (TCI) states. Each set of the first number of sets including at least a TCI state configured for communicating in a downlink direction. At operation 1304, the UE determining, based on an indication contained in the first configuration, that the first number of sets of TCI states are activated for communication with a first TRP selected from the first TRP and a second TRP. At operation 1306, activate the first number of sets of TCI states for communicating with the first TRP.

At operation 1308, the UE receives, from the first TRP, first DCI including an indication indicating (a) a first set of TCI states of the first number of sets and (b) a first direction selected from the downlink direction and the uplink direction. At operation 1310, the UE selects, from the first set, a first TCI state configured for communicating with the first TRP in the first direction. At operation 1312, the UE communicates with the first TRP in the first direction in the first TCI state.

The UE receives, from the first TRP, second DCI including an indication indicating (a) the first set and (b) a second direction selected from the downlink direction and the uplink direction. The UE selects, from the first set, a second TCI state configured for communicating with the first TRP in the second direction. The UE communicates with the first TRP in the second direction in the second TCI state.

At operation 1314, the UE receives a second configuration for activating a second number of sets of TCI states. Each set of the second number of sets includes at least a TCI state configured for communicating in a downlink direction. At operation 1316, the UE determines, based on an indication contained in the second configuration, that the second number of sets of TCI states are activated for communicating with the second TRP. At operation 1318, the UE activates the second number of sets of TCI states for communicating with the second TRP.

In certain configurations, the UE receives, from the second TRP, third DCI including an indication indicating (a) a third set of TCI states of the second number of sets and (b) a first direction selected from the downlink direction and the uplink direction. The UE selects, from the third set, a third TCI state configured for communicating with the second TRP in the first direction. The UE communicates with the second TRP in the first direction in the third TCI state.

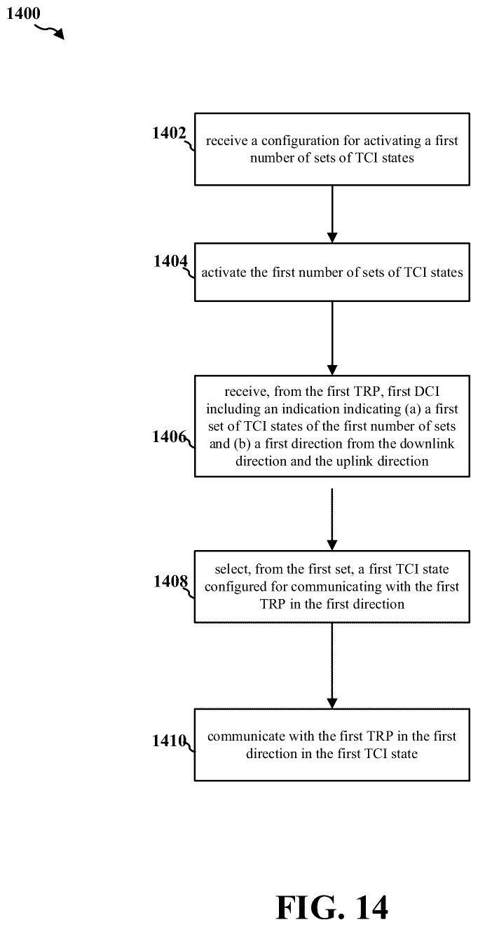

FIG. 14 is a flow chart 1400 of a third method (process) for activating TCI states. The method may be performed by a UE (e.g., the UE 704). At operation 1402, the UE receives a configuration for activating a first number of sets of TCI states. Each set of the first number of sets includes at least one of a TCI state configured for communicating with a first TRP in a downlink direction, a TCI state configured for communicating with a second TRP in a downlink direction, a TCI state configured for communicating with the first TRP in an uplink direction, and a TCI state configured for communicating with the second TRP in an uplink direction.

At operation 1404, the UE activates the first number of sets of TCI states. At operation 1406, the UE receives, from the first TRP, first DCI including an indication indicating (a) a first set of TCI states of the first number of sets and (b) a first direction from the downlink direction and the uplink direction. At operation 1408, the UE selects, from the first set, a first TCI state configured for communicating with the first TRP in the first direction. At operation 1410, the UE communicates with the first TRP in the first direction in the first TCI state.

In certain configurations, the configuration includes (a) a first indication associated with the each set indicating whether the each set includes the TCI state configured for communicating with the second TRP in the downlink direction and (b) a second indication associated with the each set indicating whether the each set includes the TCI state configured for communicating with the second TRP in the uplink direction.

In certain configurations, the configuration includes (a) a first indication associated with the each set indicating whether the each set includes at least the TCI state configured for communicating with the first TRP in the downlink direction, (b) a second indication associated with the each set indicating whether the each set includes the TCI state configured for communicating with the second TRP in the downlink direction, (c) a third indication associated with the each set indicating whether the each set includes at least the TCI state configured for communicating with the first TRP in the uplink direction, and (d) a fourth indication associated with the each set and indicating whether the each set includes the TCI state configured for communicating with the second TRP in the uplink direction.

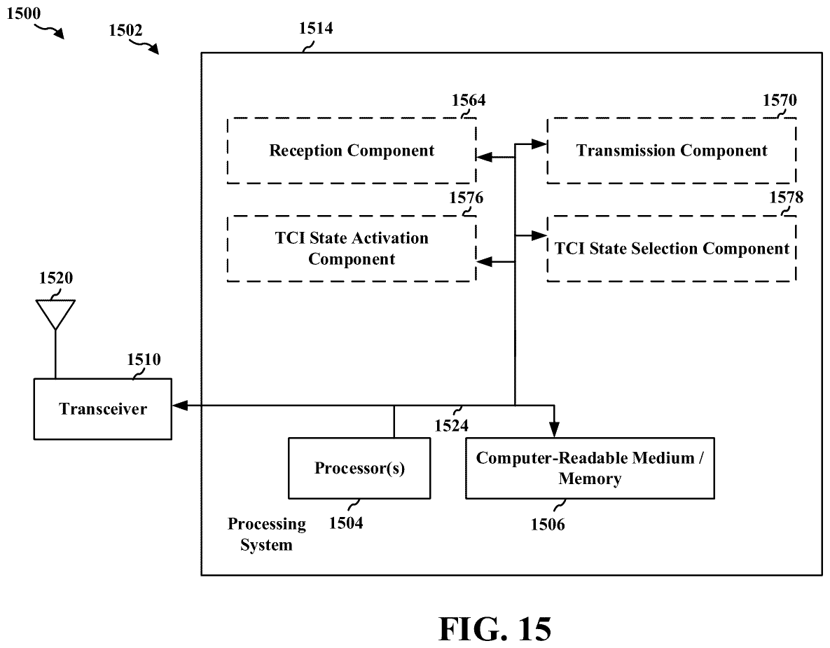

FIG. 15 is a diagram 1500 illustrating an example of a hardware implementation for an apparatus 1502 employing a processing system 1514. The apparatus 1502 may be a UE. The processing system 1514 may be implemented with a bus architecture, represented generally by a bus 1524. The bus 1524 may include any number of interconnecting buses and bridges depending on the specific application of the processing system 1514 and the overall design constraints. The bus 1524 links together various circuits including one or more processors and/or hardware components, represented by one or more processors 1504, a reception component 1564, a transmission component 1570, a TCI state activation 1576, a TCI state selection 1578, and a computer-readable medium/memory 1506. The bus 1524 may also link various other circuits such as timing sources, peripherals, voltage regulators, and power management circuits, etc.

The processing system 1514 may be coupled to a transceiver 1510, which may be one or more of the transceivers 254. The transceiver 1510 is coupled to one or more antennas 1520, which may be the communication antennas 252.

The transceiver 1510 provides a means for communicating with various other apparatus over a transmission medium. The transceiver 1510 receives a signal from the one or more antennas 1520, extracts information from the received signal, and provides the extracted information to the processing system 1514, specifically the reception component 1564. In addition, the transceiver 1510 receives information from the processing system 1514, specifically the transmission component 1570, and based on the received information, generates a signal to be applied to the one or more antennas 1520.

The processing system 1514 includes one or more processors 1504 coupled to a computer-readable medium/memory 1506. The one or more processors 1504 are responsible for general processing, including the execution of software stored on the computer-readable medium/memory 1506. The software, when executed by the one or more processors 1504, causes the processing system 1514 to perform the various functions described supra for any particular apparatus. The computer-readable medium/memory 1506 may also be used for storing data that is manipulated by the one or more processors 1504 when executing software. The processing system 1514 further includes at least one of the reception component 1564, the transmission component 1570, the TCI state activation 1576, and the TCI state selection 1578. The components may be software components running in the one or more processors 1504, resident/stored in the computer readable medium/memory 1506, one or more hardware components coupled to the one or more processors 1504, or some combination thereof. The processing system 1514 may be a component of the UE 250 and may include the memory 260 and/or at least one of the TX processor 268, the RX processor 256, and the communication processor 259.

In one configuration, the apparatus 1502 for wireless communication includes means for performing each of the operations of FIGS. 12-14. The aforementioned means may be one or more of the aforementioned components of the apparatus 1502 and/or the processing system 1514 of the apparatus 1502 configured to perform the functions recited by the aforementioned means.

As described supra, the processing system 1514 may include the TX Processor 268, the RX Processor 256, and the communication processor 259. As such, in one configuration, the aforementioned means may be the TX Processor 268, the RX Processor 256, and the communication processor 259 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
receiving a first configuration for activating a first number of sets of transmission configuration indication (TCI) states, each set of the first number of sets including at least a TCI state configured for communicating with a first TRP;
determining, based on an indication contained in the first configuration, that the first number of sets of TCI states are activated for communicating with the first TRP or a second TRP in a first direction selected from an uplink direction and a downlink direction; and
activating the first number of sets of TCI states for communicating with the first TRP or the second TRP in the first direction.

2. The method of claim 1, further comprising:
receiving, from the first TRP, first downlink control information (DCI) including an indication indicating (a) a first set of TC states of the first number of sets and (b) the first direction;
selecting, from the first set, a first TCI state configured for communicating with the first TRP in the first direction; and
communicating with the first TRP in the first direction in the first TCI state.

3. The method of claim 2, further comprising:
receiving, from a second TRP, second DCI including an indication indicating (a) the first set and (b) the first direction;
selecting, from the first set, a second TCI state configured for communicating with the second TRP in the first direction; and
communicating with the second TRP in the first direction in the second TCI state.

4. The method of claim 1, further comprising:
receiving a second configuration for activating a second number of sets of TC states, each set of the second number of sets including at least a TCI state configured for communicating with the first TRP;
determining, based on an indication contained in the second configuration, that the second number of sets of TC states are activated for communicating with the first TRP or the second TRP in a second direction selected from the uplink direction and the downlink direction; and
activating the second number of sets of TC states for communicating with the first TRP or the second TRP in the second direction.

5. The method of claim 4, further comprising:
receiving, from the first TRP, third downlink control information (DCI) including an indication indicating (a) a third set of TC states of the second number of sets and (b) the second direction;
selecting, from the third set, a third TCI state configured for communicating with the first TRP in the second direction; and
communicating with the first TRP in the second direction in the third TCI state.

6. A method of wireless communication of a user equipment (UE), comprising:
receiving a first configuration for activating a first number of sets of transmission configuration indication (TCI) states, each set of the first number of sets including at least a TCI state configured for communicating in a downlink direction;
determining, based on an indication contained in the first configuration, that the first number of sets of TCI states are activated for communication with a first TRP selected from the first TRP and a second TRP; and
activating the first number of sets of TCI states for communicating with the first TRP.

7. The method of claim 6, further comprising:
receiving, from the first TRP, first downlink control information (DCI) including an indication indicating (a) a first set of TCI states of the first number of sets and (b) a first direction selected from the downlink direction and the uplink direction;
selecting, from the first set, a first TCI state configured for communicating with the first TRP in the first direction; and
communicating with the first TRP in the first direction in the first TCI state.

8. The method of claim 7, further comprising:
receiving, from the first TRP, second DCI including an indication indicating (a) the first set and (b) a second direction selected from the downlink direction and the uplink direction;
selecting, from the first set, a second TCI state configured for communicating with the first TRP in the second direction; and
communicating with the first TRP in the second direction in the second TCI state.

9. The method of claim 6, further comprising:
receiving a second configuration for activating a second number of sets of TCI states, each set of the second number of sets including at least a TCI state configured for communicating in a downlink direction;
determining, based on an indication contained in the second configuration, that the second number of sets of TCI states are activated for communicating with the second TRP; and
activating the second number of sets of TCI states for communicating with the second TRP.

10. The method of claim 9, further comprising:
receiving, from the second TRP, third DCI including an indication indicating (a) a third set of TCI states of the second number of sets and (b) a first direction selected from the downlink direction and the uplink direction;
selecting, from the third set, a third TCI state configured for communicating with the second TRP in the first direction; and
communicating with the second TRP in the first direction in the third TCI state.

11. A method of wireless communication of a user equipment (UE), comprising:
receiving a configuration for activating a first number of sets of transmission configuration indication (TCI) states, each set of the first number of sets including at least one of a TCI state configured for communicating with a first TRP in a downlink direction, a TCI state configured for communicating with a second TRP in a downlink direction, a TCI state configured for communicating with the first TRP in an uplink direction, and a TCI state configured for communicating with the second TRP in an uplink direction; and
activating the first number of sets of TC states.

12. The method of claim 11, further comprising:
receiving, from the first TRP, first downlink control information (DCI) including an indication indicating (a) a first set of TC states of the first number of sets and (b) a first direction from the downlink direction and the uplink direction;
selecting, from the first set, a first TCI state configured for communicating with the first TRP in the first direction; and
communicating with the first TRP in the first direction in the first TCI state.

13. The method of claim 11, wherein the configuration includes (a) a first indication associated with the each set indicating whether the each set includes the TCI state configured for communicating with the second TRP in the downlink direction and (b) a second indication associated with the each set indicating whether the each set includes the TCI state configured for communicating with the second TRP in the uplink direction.

14. The method of claim 11, wherein the configuration includes (a) a first indication associated with the each set indicating whether the each set includes at least the TCI state configured for communicating with the first TRP in the downlink direction, (b) a second indication associated with the each set indicating whether the each set includes the TCI state configured for communicating with the second TRP in the downlink direction, (c) a third indication associated with the each set indicating whether the each set includes at least the TCI state configured for communicating with the first TRP in the uplink direction, and (d) a fourth indication associated with the each set and indicating whether the each set includes the TCI state configured for communicating with the second TRP in the uplink direction.
